(19) United States
(12) Patent Application Publication
(10) Pub. No.: US 2012/0068994 A1
(43) Pub. Date: Mar. 22, 2012

(54) DISPLAY DEVICE

(75) Inventors: Hung-Chun Li, Taipei County (TW); Mu-Shan Liao, Changhua County (TW); Tung-Hsin Lan, Taipei City (TW)

(73) Assignee: CHUNGHWA PICTURE TUBES, LTD., Taoyuan (TW)

(21) Appl. No.: 12/940,053

(22) Filed: Nov. 5, 2010

(30) Foreign Application Priority Data
Sep. 21, 2010 (TW) 99132041

(51) Int. Cl. G09G 5/00

(52) U.S. Cl. 345/213

(57) ABSTRACT

A display device including a timing controller and a display panel is provided. The timing controller provides a clock signal and an inverted signal of the clock signal. The display panel includes a substrate, a pixel array and a plurality of shift registers. The pixel array is disposed on the substrate. The shift registers are disposed on the substrate and respectively coupled to the timing controller. The shift registers sequentially output a plurality of scanning signals to drive the pixel array according to the clock signal and the inverted signal. In a display period of a frame period, frequencies of the clock signal and the inverted signal are a first frequency. In a vertical blanking period of the frame period, frequencies of the clock signal and the inverted signal are a second frequency. The second frequency is smaller than the first frequency.

### CROSS-REFERENCE TO RELATED APPLICATION

This application claims the priority benefit of Taiwan application serial no. 99132041, filed on Sep. 21, 2010. The entirety of the above-mentioned patent application is hereby incorporated by reference herein and made a part of this specification.

### BACKGROUND

1. Field of the Invention

The invention relates to a display device. Particularly, the invention relates to a display device capable of reducing power consumption.

2. Description of Related Art

In recent years, with development of semiconductor technology, portable electronic products and flat panel display produces are quickly developed. In various flat panel displays, a liquid crystal display (LCD) becomes a main stream in the display market due to its advantages of low operation voltage, no irradiation, light weight and small size, etc.

In order to reduce a fabrication cost of the LCD, some manufactures develop a method of directly fabricating multistage shift registers on a glass substrate by using thin film transistors (TFTs) to replace a conventional gate driving chip, so as to reduce the fabrication cost of the LCD.

Generally, during a vertical blanking period of a frame period, the display device does not display an image, i.e. the gate driving chip or the shift registers are in an idle state. Now, in order to save a power consumption of the display device, outputting of clock signals to the gate driving chip or the shift registers can be stopped. However, since a device with a good voltage barrier property such as a buffer, etc. is generally configured in the gate driving chip, when a scan line is coupled to a data line to transmit data signal, a scan signal of the gate driving chip is not influenced by a coupling voltage.

On the other hand, in the shift register formed by the thin film transistors, when the scan line is coupled to the data line to transmit the data signal, an internal voltage of the shift register is influenced by the coupling voltage, which may cause a miss operation of the shift register to cause image abnormity.

### SUMMARY OF THE INVENTION

The invention is directed to a display device, which can reduce power consumption and avoid image abnormity.

The invention provides a display device including a timing controller and a display panel. The timing controller provides a clock signal and an inverted signal of the clock signal. The display panel includes a substrate, a pixel array and a plurality of shift registers. The pixel array is disposed on the substrate. The shift registers are disposed on the substrate and are respectively coupled to the timing controller. The shift registers sequentially output a plurality of scanning signals according to the clock signal and the inverted signal, so as to drive the pixel array. In a display period of a frame period, frequencies of the clock signal and the inverted signal are a first frequency. In a vertical blanking period of the frame period, frequencies of the clock signal and the inverted signal are a second frequency. The second frequency is smaller than the first frequency.

In an embodiment of the invention, the second frequency is 1/n-th power of 2 of the first frequency, wherein n is a positive integer.

In an embodiment of the invention, the second frequency is ½ of the first frequency.

In an embodiment of the invention, the second frequency is ¼ of the first frequency.

According to the above descriptions, the frequencies of the clock signals during the display period are greater than the frequencies of the clock signals during the vertical blanking period. In this way, power consumption for generating the clock signals is reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a display device according to an embodiment of the invention.

FIG. 2 is a schematic diagram illustrating driving waveforms according to an embodiment of the invention.

FIG. 3 is circuit schematic diagram of the shift register SR1 of FIG. 1 according to an embodiment of the invention.

FIG. 4 is schematic diagram illustrating driving waveforms when outputting of clock signals is stopped during a vertical blanking period.

### DETAILED DESCRIPTION OF DISCLOSED EMBODIMENTS

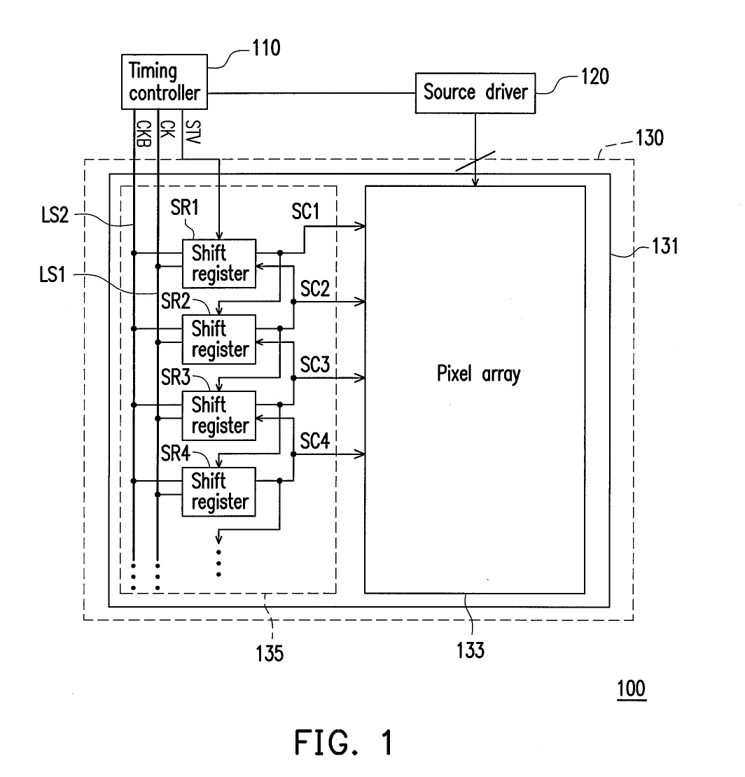

FIG. 1 is a system schematic diagram of a display device according to an embodiment of the invention. Referring to FIG. 1, the display device 100 includes a timing controller 110, a source driver 120 and a display panel 130. The display panel 130 includes a substrate 131, a pixel array 133 and a gate driving circuit 135. In the present embodiment, the gate driving circuit 135 is disposed on the substrate 131, and is located at a left side of the pixel array 133, though in other embodiments, the gate driving circuit 135 can be disposed at a right side, on the top or bottom of the pixel array 133. Moreover, the pixel array 133 on the substrate 131 is a display region of the display panel 130, and a region where the gate driving circuit 135 is located is a non-display region of the display panel 130.

The timing controller 110 provides a start signal STV and clock signals CK and CKB, wherein the clock signal CKB is an inverted, signal of the clock signal CK. The gate driving circuit 135 sequentially output scanning signals SC1, SC2, SC3, SC4, . . . , etc. according to the start signal STV and the clock signals CK and CKB, so as to drive each row of pixels (not shown) in the pixel array 133. The source driver 120 is controlled by the timing controller 110 and outputs corresponding display data to the driven pixels.

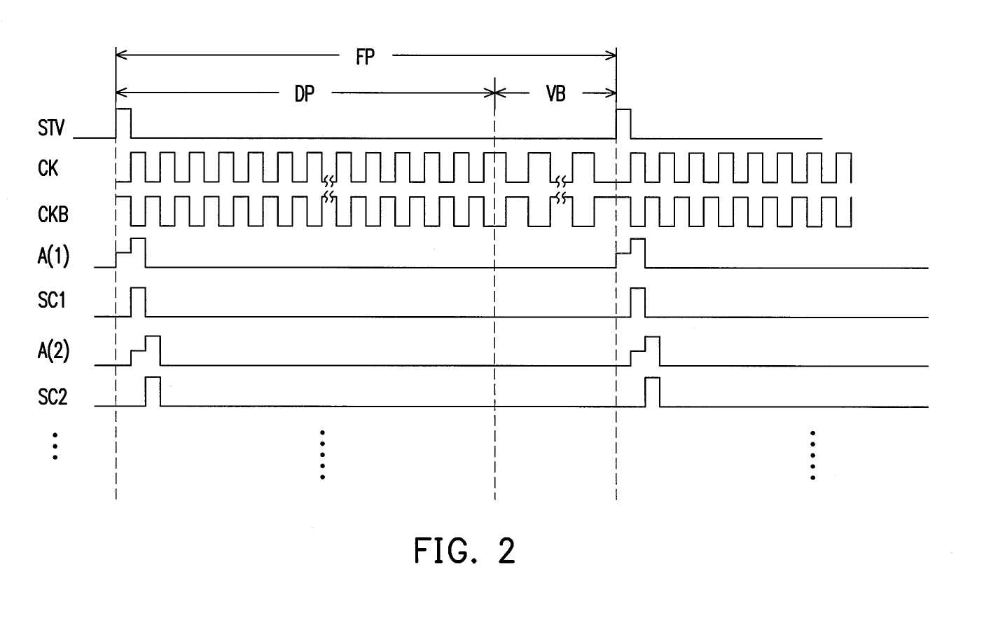

FIG. 2 is a schematic diagram illustrating driving waveforms according to an embodiment of the invention. Referring to FIG. 1 and FIG. 2, in the present embodiment, during a frame period FP, the clock signals CK and CKB in a display period DP are different to the clock signals CK and CKB in a vertical blanking period VB. In detail, the frequencies (referred to as a first frequency hereinafter) of the clock signals CK and CKB in the display period DP are greater than the frequencies (referred to as a second frequency hereinafter) of the clock signals CK and CKB in the vertical blanking period VB. Moreover, when the second frequency is ½ of the first frequency, power consumption for generating the clock signals CK and CKB is reduced for about 5%. When the second frequency is ¼ of the first frequency, power consumption for generating the clock signals CK and CKB is reduced for about 7.5%.

Referring to FIG. 1, the gate driving circuit 135 includes shift registers SR1, SR2, SR3, SR4, . . . , etc. The shift registers SR1, SR2, SR3, SR4, simultaneously receive the clock signal CK and the clock signal CKB. The clock signal CK is transmitted to the shift registers SR1, SR2, SR3, SR4, . . . , etc. through a signal line LS1 on the substrate 131, and the clock signal CKB is transmitted to the shift registers SR1, SR2, SR3, SR4, . . . , etc. through a signal line LS2 on the substrate 131. Moreover, the signal lines LS1 and LS2 can be disposed in the gate driving circuit 135.

Referring to FIG. 1 and FIG. 2, in the present embodiment, when the shift register SR1 receives the start signal STV, the shift register SR1 is set to a driving state. Then, when the clock signal CK received by the shift register SR1 is enabled (which, for example, has a high voltage level) and the clock signal CKB is disabled (which, for example, has a low voltage level), the shift register SR1 outputs the scan signal SC1. In other words, the shift register SR1 outputs the scan signal SC1 according to the start signal STV and the clock signals CK and CKB. Moreover, the scan signal SC1 is transmitted to the shift register SR2.

When the shift register SR2 receives the scan signal SC1, the shift register SR2 is set to the driving state. Then, when the clock signal CK received by the shift register SR2 is disabled and the clock signal CKB is enabled, the shift register SR2 outputs the scan signal SC2. In other words, the shift register SR2 outputs the scan signal SC2 according to the scan signal SC1 and the clock signals CK and CKB. Moreover, the scan signal SC2 is transmitted to the shift registers SR1 and SR3. Now, when the shift register SR1 receives the scan signal SC2, the shift register SR1 is switched to a halt state to stop outputting the scan signal SC1, so as to avoid overlapping the scan signal SC1 and the scan signal SC2.

When the shift register SR3 receives the scan signal SC2, the shift register SR3 is set to the driving state. Then, when the clock signal CK received by the shift register SR3 is enabled and the clock signal CKB is disabled, the shift register SR3 outputs the scan signal SC3. In other words, the shift register SR3 outputs the scan signal SC3 according to the scan signal SC2 and the clock signals CK and CKB. Moreover, the scan signal SC3 is transmitted to the shift registers SR2 and SR4. Now, when the shift register SR2 receives the scan signal SC3, the shift register SR2 is switched to the halt state to stop outputting the scan signal SC2, so as to avoid overlapping the scan signal SC2 and the scan signal SC3.

Operations of the other shift registers (for example, the shift register SR4, etc.) can be deduced by analogy, and the corresponding scan signals (for example, the scan signal SC4, etc.) are accordingly output. In this way, the gate driving circuit 135 can sequentially output the scan signals SC1, SC2, SC3, . . . , etc. to respectively drive each row of the pixels (not shown) in the pixel array 133.

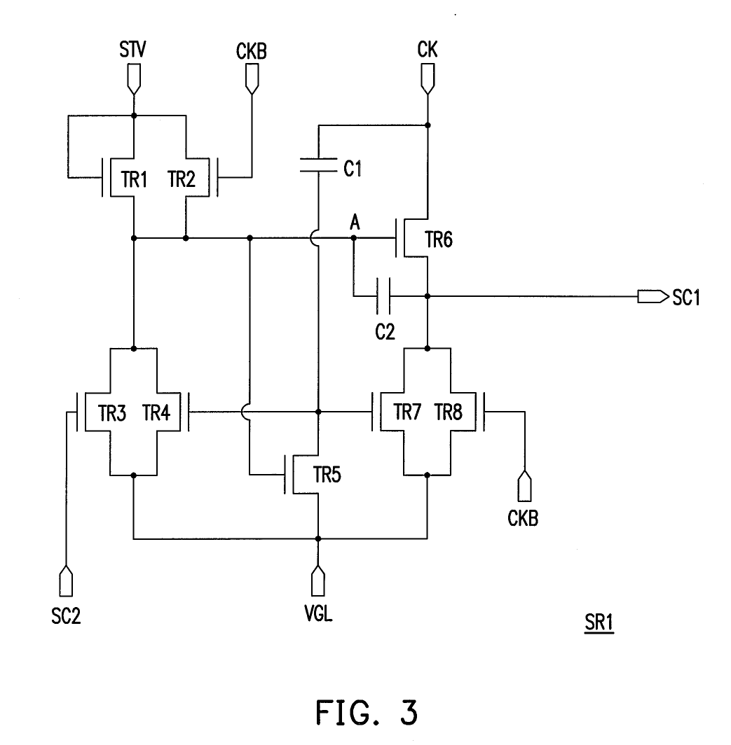

FIG. 3 is circuit schematic diagram of the shift register SR1 of FIG. 1 according to an embodiment of the invention. Referring to FIG. 3, the shift register SR1 includes transistors TR1-TR8, and capacitors C1 and C2. A drain of the transistor TR1 receives the start signal STV, and a gate of the transistor TR1 is coupled to the drain of the transistor TR1. A drain of the transistor TR2 is coupled to the drain of the transistor TR1, a source of the transistor TR2 is coupled to a source of the transistor TR1, and a gate of the transistor TR2 receives the clock signal CKB. A drain of the transistor TR3 is coupled to the source of the transistor TR1, a source of the transistor TR3 is coupled to a low level gate voltage VGL, and a gate of the transistor TR3 receives the scan signal SC2. A drain of the transistor TR4 is coupled to the source of the transistor TR1, and a source of the transistor TR4 is coupled to the low level gate voltage VGL.

A drain of the transistor TR5 is coupled to a gate of the transistor TR4, a source of the transistor TR5 is coupled to the low level gate voltage VGL, and a gate of the transistor TR5 is coupled to the source of the transistor TR1. A drain of the transistor TR6 receives the clock signal CK, a source of the transistor TR6 outputs the scan signal SC1, and a gate of the transistor TR6 is coupled to the source of the transistor TR1. A drain of the transistor TR7 is coupled to the source of the transistor TR6, a source of the transistor TR7 is coupled to the low level gate voltage VGL, and a gate of the transistor TR7 is coupled to the gate of the transistor TR4. A drain of the transistor TR8 is coupled to the source of the transistor TR6, a source of the transistor TR8 is coupled to the low level gate voltage VGL, and a gate of the transistor TR8 receives the clock signal CKB. The capacitor C1 is coupled between the drain of the transistor TR6 and the drain of the transistor TR5. The capacitor C2 is coupled between the gate of the transistor TR6 and the source of the transistor TR6.

Referring to FIG. 2 and FIG. 3, in the display period DP of the frame period FP, when the transistor TR1 receives the start signal STV, the transistor TR1 is conducted in response to the start signal STV, and outputs the start signal STV to charge the capacitor C2, i.e. a voltage of a node A is increased, and a waveform thereof is shown by a waveform A(1) in FIG. 2. The waveform A(1) represents a voltage waveform of the node A of the shift register SR1, and a waveform A(2) represents a voltage waveform of a node A of the shift register SR2.

When the voltage of the capacitor C2 exceeds threshold voltages of the transistors TR5 and TR6, the transistors TR5 and TR6 are conducted, and now the shift register SR1 is in the driving state. Moreover, the conducted transistor TR5 transmits the low level gate voltage VGL (i.e. a low voltage level) to the gates of the transistors TR4 and TR7, so that the transistors TR4 and TR7 are in a non-conducting state, so as to avoid miss conduction of the transistors TR4 and TR7.

Then, when the clock signal CK is enabled, the transistor TR6 outputs the enabled clock signal CK to serve as the scan signal SC1, and the capacitor C2 and the transistor TR6 form a bootstrap configuration. Therefore, the voltage of the node A is again increased, so that the transistor TR6 is maintained in the conducting state and continually outputs the scan signal SC1. Then, when the gate of the transistor TR3 receives the scan signal SC2, the transistor TR3 is conducted. The conducted transistor TR3 pulls down a voltage level of the gate of the transistor TR6 so that the transistor TR6 is not conducted, and now the shift register SR1 is in the halt state.

When the clock signal CKB is enabled, the transistors TR2 and TR8 are conducted. The conducted transistor TR8 pulls down a voltage level of the source of the transistor TR6 to a low voltage level. Moreover, during a period without receiving the start signal STV, the drain of the transistor TR2 receives the low voltage level, so that the conducted transistor TR2 can pull down the voltage level of the gate of the transistor TR6 to the low voltage level. In this way, the shift register SR1 completely stops outputting the scan signal SC1. Circuit structures of the other shift registers (for example, SR2, SR3, SR4, . . . , etc.) are similar to that of the shift register SR1, and operation principles thereof are also similar, so that detailed descriptions thereof are not repeated.

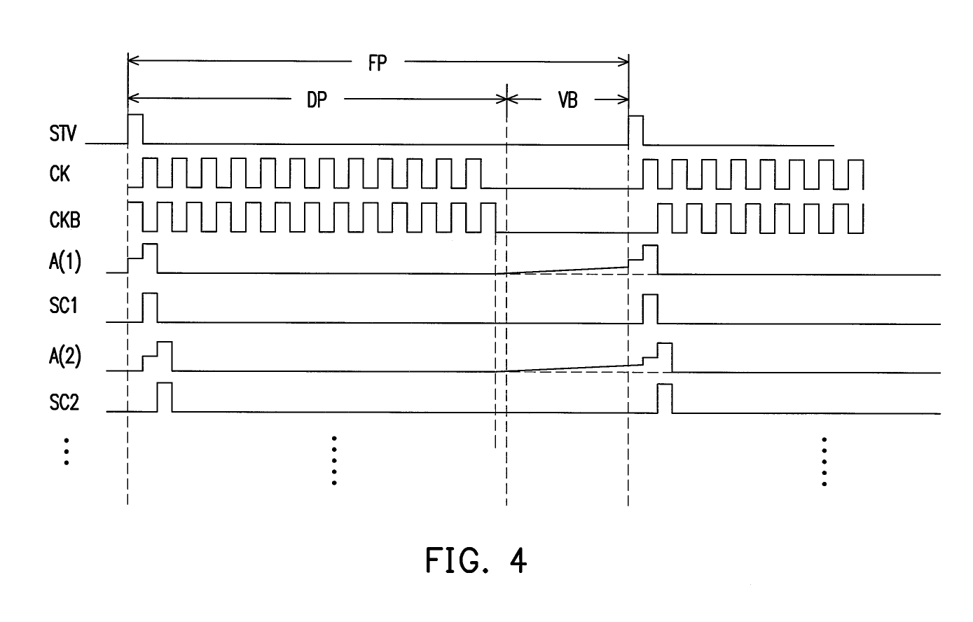

FIG. 4 is schematic diagram illustrating driving waveforms when outputting of clock signals is stopped during the vertical blanking period. Referring to FIG. 3 and FIG. 4, if outputting of the clock signals CK and CKB is stopped during the vertical blanking period VB of the frame period FP, a scan line (not shown) in the pixel array 133 is coupled to a data line (not shown) to transmit a data signal and generate a coupling voltage, and the coupling voltage is transmitted to the node A of the shift register through the capacitor C2. Moreover, since the transistors TR1-TR8 are all in the non-conducting state, the node A serves as a common coupling point of a plurality of equivalent capacitors. When the coupling voltage is transmitted to the node A through the capacitor C2, the voltage of the node A is gradually increased to probably cause a miss operation, and a waveform thereof is shown by waveforms A(1) and A(2) of FIG. 4. Therefore, during the vertical blanking period VB, outputting of the clock signals CK and CKB cannot be stopped.

In summary, in the display device of the invention, the frequencies of the clock signals during the display period are greater than the frequencies of the clock signals during the vertical blanking period. In this way, power consumption for generating the clock signals is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display device, comprising:
a timing controller, for providing a clock signal and an inverted signal; and
a display panel, comprising:
a substrate;
a pixel array, disposed on the substrate; and
a plurality of shift registers, disposed on the substrate, and respectively coupled to the timing controller, the shift registers sequentially outputting a plurality of scanning signals according to the clock signal and the inverted signal, so as to drive the pixel array,
wherein in a display period of a frame period, frequencies of the clock signal and the inverted signal are a first frequency, and in a vertical blanking period of the frame period, frequencies of the clock signal and the inverted signal are a second frequency, wherein the second frequency is smaller than the first frequency.

2. The display device as claimed in claim 1, wherein the second frequency is 1/n-th power of 2 of the first frequency, wherein n is a positive integer.

3. The display device as claimed in claim 2, wherein the second frequency is ½ of the first frequency.

4. The display device as claimed in claim 2, wherein the second frequency is ¼ of the first frequency.
